(19) United States
(12) Patent Application Publication
(10) Pub. No.: US 2024/0103161 A1
(43) Pub. Date: Mar. 28, 2024

(54) ACOUSTIC ACTIVE SENSOR DEVICE

(71) Applicant: Panasonic Intellectual Property Corporation of America, Torrance, CA (US)

(72) Inventor: Toshiyuki MATSUMURA, Osaka (JP)

(73) Assignee: Panasonic Intellectual Property Corporation of America, Torrance, CA (US)

(21) Appl. No.: 18/529,327

(22) Filed: Dec. 5, 2023

Related U.S. Application Data
(63) Continuation of application No. PCT/JP2022/018059, filed on Apr. 18, 2022.

(30) Foreign Application Priority Data
Jun. 11, 2021 (JP) 2021-097889

(51) Int. Cl. G01S 15/86; G01S 7/521; G01S 15/06

(52) U.S. Cl. CPC G01S 15/86; G01S 7/521; G01S 15/06; H04R 9/025

(57) ABSTRACT

This acoustic active sensor device comprises: a camera unit; an acoustic actuator having a sound generation unit that generates a sound; and a sound detection unit having a plurality of microphones which detect a reflective sound of the sound generated by the sound generation unit. The sound generation unit and the sound detection unit are disposed around the outer circumference of the camera unit and are centered thereon.

### TECHNICAL FIELD

The present disclosure relates to an acoustic active sensor device.

### BACKGROUND ART

Patent Literature 1 below discloses a display device capable of simulatively displaying a sound pressure in a sound field space that is a measurement target. The display device includes: a display body that has a plurality of displaceable portions and expresses the sound field space; a plurality of microphones disposed in the sound field space; and a plurality of drive units that displace, in accordance with output of each microphone, each portion of the display body corresponding to disposing positions of each microphone.

According to Patent Literature 1, position information of a target object can be acquired by detecting an arrival direction of a sound, but image information of the target object cannot be acquired at the same time.

### CITATION LIST

### Patent Literature

### Patent Literature 1: JP H09-81066 A

### SUMMARY OF INVENTION

An object of the present disclosure is to obtain an acoustic active sensor device capable of highly accurately acquiring position information of a target object and image information of the target object.

### Means for Solving the Problem

In order to solve the above problem, an acoustic active sensor device according to an aspect of the present disclosure includes: a camera unit; an acoustic actuator having a sound generation unit that generates a sound; and a sound detection unit including a plurality of microphones that detect a reflective sound of a sound generated by the sound generation unit, in which the sound generation unit and the sound detection unit are disposed on an outer peripheral side centered on the camera unit.

### BRIEF DESCRIPTION OF DRAWINGS

FIG. 1 is a plan view schematically illustrating a configuration of an acoustic active sensor device according to a first embodiment of the present disclosure.

FIG. 2 is a cross-sectional view schematically illustrating a cross-sectional structure of the acoustic active sensor device according to the first embodiment of the present disclosure.

FIG. 3 is a view for explaining a beamforming method using delay sum.

FIG. 4 is a plan view schematically illustrating a configuration of an acoustic active sensor device according to a second embodiment of the present disclosure.

FIG. 5 is a plan view schematically illustrating a configuration of an acoustic active sensor device according to a third embodiment of the present disclosure.

FIG. 6 is a cross-sectional view schematically illustrating a cross-sectional structure of an acoustic active sensor device according to a fourth embodiment of the present disclosure.

FIG. 7 is a plan view schematically illustrating configurations of a frame and a microphone.

FIG. 8 is a plan view schematically illustrating a modification of the configurations of the frame and the microphone.

### DESCRIPTION OF EMBODIMENTS

(Knowledge Underlying the Present Disclosure)

There is known an acoustic active sensor device capable of acquiring position information of a target object in a space by radiating sound from a speaker toward the space and detecting reflective sound from the target object with a microphone.

By mounting a camera on the acoustic active sensor device and photographing a space with the camera, it is possible to acquire not only position information of a target object but also image information thereof.

However, for example, when the camera unit and the microphone array are disposed side by side, a positional relationship (particularly, an angle) with the target object is different between the camera unit and the microphone array, and this causes a deviation. Therefore, the position of the target object included in the image photographed by the camera unit does not match the position information detected by the microphone array, and as a result, it is difficult to highly accurately acquire the image information of the target object.

In order to solve such problem, the present inventor has obtained knowledge that the center axis of a microphone array and the center axis of a camera unit can be matched by disposing the camera unit at the center of a device and disposing the microphone array concentrically centered on the camera unit, whereby the image information of the target object can be highly accurately acquired, and has devised the present disclosure.

Next, each aspect of the present disclosure will be described.

An acoustic active sensor device according to an aspect of the present disclosure includes: a camera unit; an acoustic actuator having a sound generation unit that generates a sound; and a sound detection unit including a plurality of microphones that detect a reflective sound of a sound generated by the sound generation unit, in which the sound generation unit and the sound detection unit are disposed on an outer peripheral side centered on the camera unit.

According to this aspect, by disposing the sound generation unit and the sound detection unit on the outer peripheral side centered on the camera unit, it is possible to match the center axes of the sound generation unit, the sound detection unit, and the camera unit. Therefore, the positional relationship with the target object is common among the sound generation unit, the sound detection unit, and the camera unit. Therefore, the position of the target object included in the image photographed by the camera unit can be accurately specified based on the position information detected by the sound detection unit, and as a result, the image information of the target object can be highly accurately acquired.

In the above aspect, the sound generation unit and the sound detection unit are disposed concentrically centered on the camera unit.

According to this aspect, by disposing the sound generation unit and the sound detection unit concentrically centered on the camera unit, it becomes possible to completely match the center axes of the sound generation unit, the sound detection unit, and the camera unit.

In the above aspect, the sound generation unit includes a circular vibration plate centered on the camera unit.

According to this aspect, since the sound generation unit has the circular vibration plate centered on the camera unit, it is possible to radiate a sonar sound from the vibration plate whose center axis matches the center axes of the sound detection unit and the camera unit.

In the above aspect, the sound detection unit includes a first microphone array disposed outside relative to the sound generation unit.

According to this aspect, by disposing the first microphone array outside relative to the sound generation unit (on the side opposite to the camera unit), it is possible to configure the first microphone array by a large number of microphones. Since the intervals among the plurality of microphones constituting the first microphone array can be widened, it become advantageous for analysis of reflective sound including a low frequency component.

In the above aspect, the sound detection unit includes a second microphone array disposed inside relative to the sound generation unit.

According to this aspect, by disposing the second microphone array inside relative to the sound generation unit (on the same side as the camera unit), it is possible to narrow the intervals among the plurality of microphones constituting the second microphone array, and therefore it becomes advantageous for analysis of reflective sound including a high frequency component.

In the above aspect, the acoustic actuator further includes a magnetic circuit that generates a magnetic flux for vibrating the sound generation unit, a hole portion is formed in a center part of the magnetic circuit in plan view, and the camera unit is disposed in the hole portion.

According to this aspect, by forming the hole portion in the center part of the magnetic circuit in plan view and inserting the camera unit into the hole portion, it is possible to dispose the camera unit in the center part of the acoustic active sensor device.

In the above aspect, regarding a front traveling direction of a sound generated by the sound generation unit, a front end part of the camera unit protrudes forward relative to the front end part of the sound generation unit.

According to this aspect, since the front end part of the camera unit protrudes forward relative to the front end part of the sound generation unit, the front end part of the camera unit can function as a diffuser for controlling the directivity of the sonar sound radiated from the sound generation unit.

Embodiments of the present disclosure will be described in detail below with reference to the drawings. Note that elements denoted by the same reference numerals in different drawings represent the same or corresponding elements.

Note that each of the embodiments described below shows one specific example of the present disclosure. Numerical values, shapes, components, steps, order of steps, and the like shown in the following embodiments are merely one example, and are not intended to limit the present disclosure. A component that is not described in an independent claim representing the highest concept among components in the embodiments below is described as an arbitrary component. In all the embodiments, respective contents can be combined.

### First Embodiment

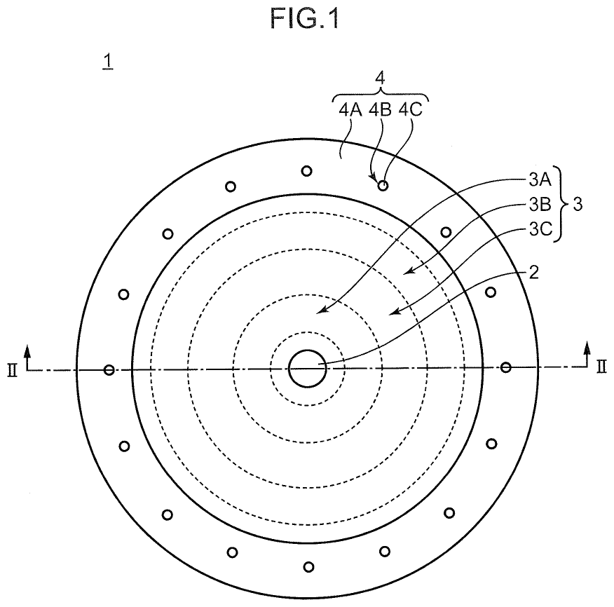

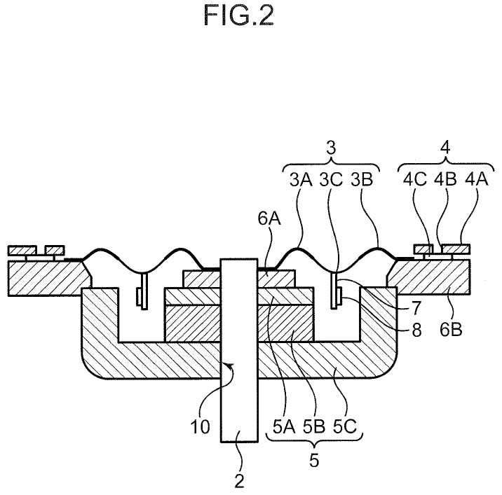

FIG. 1 is a plan view schematically illustrating the configuration of an acoustic active sensor device 1 according to the first embodiment of the present disclosure. FIG. 2 is a cross-sectional view schematically illustrating a cross-sectional structure related to a position along line II-II illustrated in FIG. 1.

The acoustic active sensor device 1 includes a camera unit 2, an acoustic actuator, and a sound detection unit 4.

The camera unit 2 includes a lens group, an image sensor such as a CCD or a CMOS, and a signal processing circuit (all not illustrated).

The acoustic actuator includes a sound generation unit 3, a magnetic circuit 5, a bobbin 7, and a voice coil 8.

The sound generation unit 3 includes an inner edge 3A, an outer edge 3B, and a vibration plate 3C. Each of the inner edge 3A, the outer edge 3B, and the vibration plate 3C has a circular shape, and the inner edge 3A, the vibration plate 3C, and the outer edge 3B are concentrically disposed in this order from the inside centered on the center axis of the camera unit 2. The material of the inner edge 3A and the outer edge 3B is elastomer or the like, and the material of the vibration plate 3C is metal, resin, paper, woven fabric, or the like.

An inner peripheral edge of the inner edge 3A is fixed to a support member 6A, and an outer peripheral edge of the inner edge 3A is fixed to an inner peripheral edge of the vibration plate 3C by adhesion or the like. The material of the support member 6A is resin or the like.

An outer peripheral edge of the outer edge 3B is fixed to a frame 6B, and an inner peripheral edge of the outer edge 3B is fixed to an outer peripheral edge of the vibration plate 3C by adhesion or the like. The material of the frame 6B is resin or the like.

The bobbin 7 having a tubular shape is fixed to the back surface (surface opposite to the radiation direction of the sonar sound) of the vibration plate 3C by adhesion or the like. The voice coil 8 such as a copper wire or a silver wire is wound around the bobbin 7.

The magnetic circuit 5 includes a plate 5A, a magnet 5B, and a yoke 5C. The voice coil 8 is disposed in a gap between an outer surface of the plate 5A and an inner surface of an end part of the yoke 5C. Due to this, the voice coil 8 is positioned in a magnetic field generated by the magnet 5B.

In FIG. 2, the orientation of the magnetic flux of the magnetic field generated by the magnet 5B is the left-right direction of the paper surface in the gap. The orientation of the current flowing through the voice coil 8 is a front direction or a depth direction of the paper surface in the gap. Therefore, when the current flows through the voice coil 8, the voice coil 8 moves in the up-down direction on the paper surface, and as a result, the sonar sound generated due to vibration of the vibration plate 3C is radiated toward a space in front of the acoustic active sensor device 1 (the space in the upward direction on the paper surface in FIG. 2).

A hole portion 10 penetrating each member is formed in a center parts (center parts in plan view) of the support member 6A, the plate 5A, the magnet 5B, and the yoke 5C, and the camera unit 2 is disposed to be inserted into the hole portion 10.

The sound detection unit 4 includes a microphone board 4A and a microphone 4C. A through hole 4B is formed on the microphone board 4A, and a sound detection surface of the microphone 4C is exposed in the through hole 4B. Due to this, a reflective sound from the target object reaches the microphone 4C via the through hole 4B, and the microphone 4C detects the reflective sound. The back surface (surface opposite to the sound detection surface) of the microphone 4C is fixed to the frame 6B.

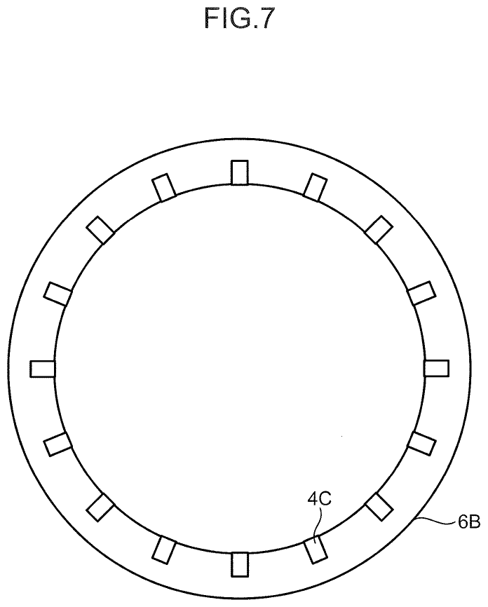

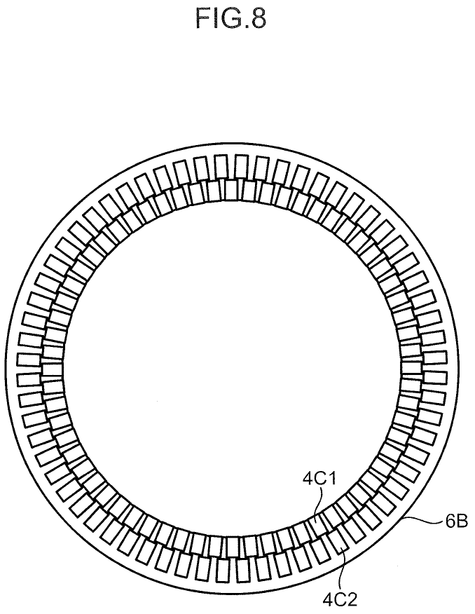

FIG. 7 is a plan view schematically illustrating the configurations of the frame 6B and the microphone 4C. With reference to FIGS. 1 and 7, the microphone board 4A has a circular shape, and is disposed concentrically with the vibration plate 3C centered on the center axis of the camera unit 2. That is, the sound generation unit 3 and the sound detection unit 4 are concentrically disposed on the outer peripheral side centered on the camera unit 2. The sound detection unit 4 has a plurality of the microphones 4C disposed side by side at equal intervals along the circumferential direction of the circle, and the plurality of microphones 4C constitute the first microphone array. In the example of the present embodiment, the first microphone array is disposed outside relative to the circle of the vibration plate 3C (on the side opposite to the camera unit 2). Note that the microphone 4C also includes an ultrasonic sensor. FIG. 8 is a plan view schematically illustrating a modification of the configurations of the frame 6B and the microphone 4C. A plurality of inner microphones 4C1 and a plurality of outer microphones 4C2 are disposed alternately in a double circular shape. This can make the interval between the adjacent microphones 4C1 and 4C2 smaller than the microphone size, and as a result, it is possible to increase the analysis frequency.

The acoustic active sensor device 1 according to the present embodiment radiates the sonar sound generated by the sound generation unit 3 toward a space, and detects the reflective sound from a target object present in the space by the plurality of microphones 4C of the sound detection unit 4. By analyzing a detection result of the reflective sound by signal processing, the acoustic active sensor device 1 acquires position information of the target object including a distance and a direction. As the signal processing for specifying the position of the target object, for example, it is possible to use a beamforming method using delay sum described later. The acoustic active sensor device 1 acquires image information of the target object by photographing the space by the camera unit 2 and specifying the position of the target object included in the photographed image based on the position information detected by the sound detection unit 4.

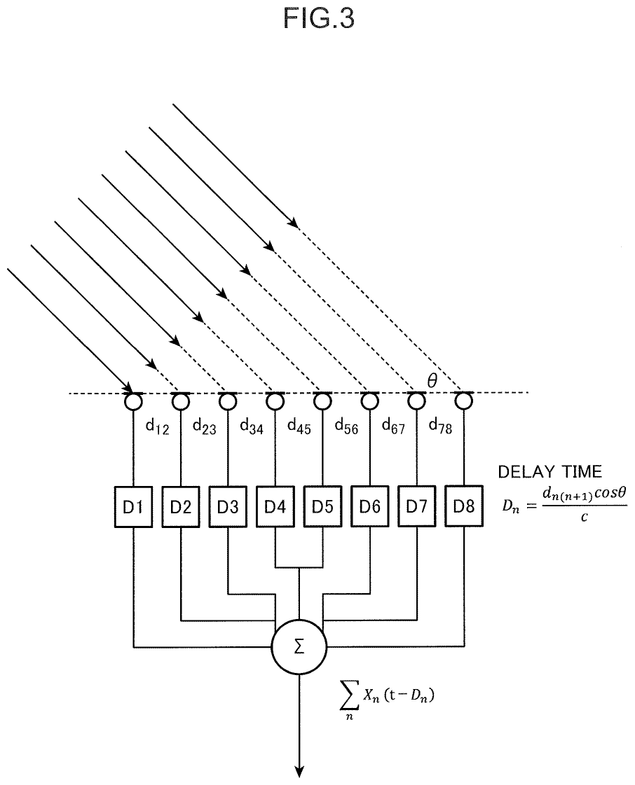

FIG. 3 is a view for explaining the beamforming method using delay sum. FIG. 3 illustrates an example using eight microphones. A delay element is connected to a subsequent stage of each microphone, and outputs from all the delay elements are added by an adder. Delay time Dn in each delay element is expressed by

Dn=dₙ₍ₙ₊₁₎cos θ/c

using light speed c, a distance d between the microphones, and an angle θ formed by the front direction of the microphone array and the arrival direction of the reflective sound.

In this manner, in the beamforming method using delay sum, phases of incident waves are aligned by the delay element connected to the subsequent stage of each microphone, and then all the outputs are added, thereby forming an acoustic beam. Then, the arrival direction of the reflective sound (i.e., the position of the target object) is specified by scanning the space while changing the angle θ. Note that the signal processing for specifying the position of the target object is not limited to the beamforming method using delay sum, and other algorithms may be used.

According to the acoustic active sensor device 1 according to the present embodiment, by disposing the sound generation unit 3 and the sound detection unit 4 on the outer peripheral side centered on the camera unit 2, it is possible to match the center axes of the sound generation unit 3, the sound detection unit 4, and the camera unit 2. Therefore, the positional relationship with the target object is common among the sound generation unit 3, the sound detection unit 4, and the camera unit 2. Therefore, the position of the target object included in the image photographed by the camera unit 2 can be accurately specified based on the position information detected by the sound detection unit 4, and as a result, the image information of the target object can be highly accurately acquired.

According to the acoustic active sensor device 1 according to the present embodiment, by disposing the sound generation unit 3 and the sound detection unit 4 concentrically centered on the camera unit 2, it becomes possible to completely match the center axes of the sound generation unit 3, the sound detection unit 4, and the camera unit 2.

According to the acoustic active sensor device 1 according to the present embodiment, since the sound generation unit 3 has the circular vibration plate 3C centered on the camera unit 2, it is possible to radiate a sonar sound from the vibration plate 3C whose center axis matches the center axes of the sound detection unit 4 and the camera unit 2.

According to the acoustic active sensor device 1 according to the present embodiment, by disposing the first microphone array outside relative to the sound generation unit 3 (on the side opposite to the camera unit 2), it is possible to configure the first microphone array by a large number of microphones 4C. Since the intervals among the plurality of microphones 4C constituting the first microphone array can be widened, it become advantageous for analysis of reflective sound including a low frequency component.

According to the acoustic active sensor device 1 according to the present embodiment, by forming the hole portion 10 in the center part of the magnetic circuit 5 in plan view and inserting the camera unit 2 into the hole portion 10, it is possible to dispose the camera unit 2 in the center part of the acoustic active sensor device 1.

### Second Embodiment

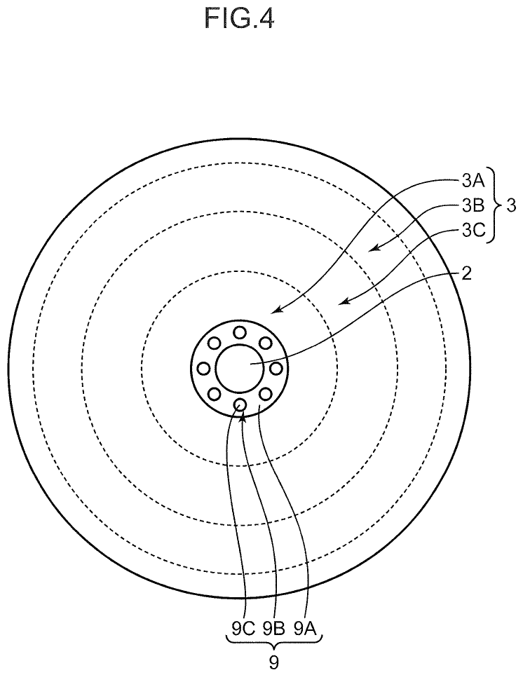

FIG. 4 is a plan view schematically illustrating the configuration of the acoustic active sensor device 1 according to the second embodiment of the present disclosure. The acoustic active sensor device 1 according to the second embodiment is configured to include a sound detection unit 9 in place of the sound detection unit 4 illustrated in FIG. 1.

The sound detection unit 9 includes a microphone board 9A and a microphone 9C. A through hole 9B is formed on the microphone board 9A, and a sound detection surface of the microphone 9C is exposed in the through hole 9B. Due to this, a reflective sound from the target object reaches the microphone 9C via the through hole 9B, and the microphone 9C detects the reflective sound. Although not illustrated in FIG. 4, the back surface (surface opposite to the sound detection surface) of the microphone 9C is fixed to the support member 6A.

The microphone board 9A has a circular shape, and is disposed concentrically with the vibration plate 3C centered on the center axis of the camera unit 2. That is, the sound generation unit 3 and the sound detection unit 9 are concentrically disposed on the outer peripheral side centered on the camera unit 2. The sound detection unit 9 has a plurality of the microphones 9C disposed side by side at equal intervals along the circumferential direction of the circle, and the plurality of microphones 9C constitute the second microphone array. In the example of the present embodiment, the second microphone array is disposed inside relative to the circle of the vibration plate 3C (on the same side as the camera unit 2).

According to the acoustic active sensor device 1 according to the present embodiment, by disposing the second microphone array inside relative to the sound generation unit 3, it is possible to narrow the intervals among the plurality of microphones 9C constituting the second microphone array, and therefore it becomes advantageous for analysis of reflective sound including a high frequency component.

### Third Embodiment

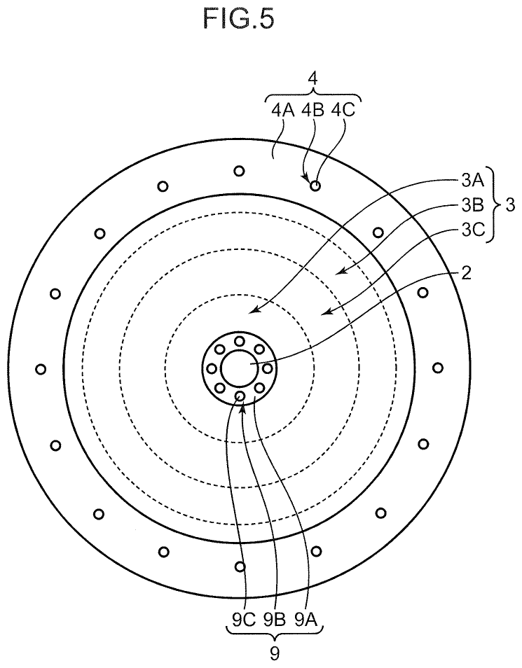

FIG. 5 is a plan view schematically illustrating the configuration of the acoustic active sensor device 1 according to the third embodiment of the present disclosure. The acoustic active sensor device 1 according to the third embodiment is configured to include the sound detection unit 9 illustrated in FIG. 4 in addition to the sound detection unit 4 illustrated in FIG. 1.

According to the acoustic active sensor device 1 according to the present embodiment, by including the first microphone array disposed outside relative to the sound generation unit 3 and the second microphone array disposed inside relative to the sound generation unit 3, it becomes advantageous for analysis of reflective sound including a low frequency component and a high frequency component.

### Fourth Embodiment

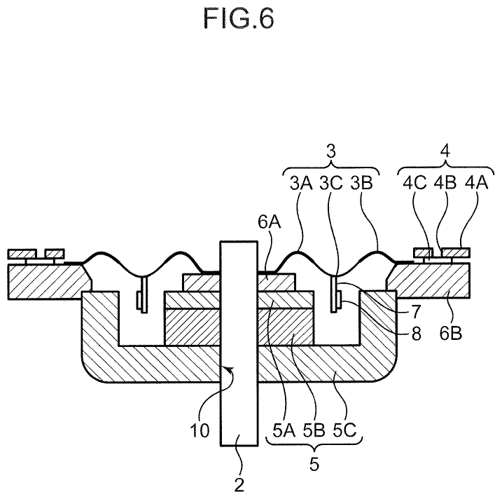

FIG. 6 is a cross-sectional view schematically illustrating a cross-sectional structure of the acoustic active sensor device 1 according to the fourth embodiment of the present disclosure.

In the present embodiment, the front end part (the upper end part in FIG. 6) of the camera unit 2 protrudes forward (upward in FIG. 6) relative to the front end part (the upper end part in FIG. 6) of the sound generation unit 3.

According to the acoustic active sensor device 1 of the present embodiment, the front end part of the camera unit 2 protrudes forward relative to the front end part of the sound generation unit 3, whereby it is possible to cause the front end part of the camera unit 2 to function as a diffuser for controlling the directivity of the sonar sound radiated from the sound generation unit 3.

### INDUSTRIAL APPLICABILITY

The present disclosure is particularly useful for application to an object detection system using an acoustic active sensor device.

1. An acoustic active sensor device comprising:
a camera unit;
an acoustic actuator having a sound generation unit that generates a sound; and
a sound detection unit including a plurality of microphones that detect a reflective sound of a sound generated by the sound generation unit, wherein
the sound generation unit and the sound detection unit are disposed on an outer peripheral side centered on the camera unit.

2. The acoustic active sensor device according to claim 1, wherein the sound generation unit and the sound detection unit are disposed concentrically centered on the camera unit.

3. The acoustic active sensor device according to claim 1, wherein the sound generation unit includes a circular vibration plate centered on the camera unit.

4. The acoustic active sensor device according to claim 1, wherein the sound detection unit includes a first microphone array disposed outside relative to the sound generation unit.

5. The acoustic active sensor device according to claim 1, wherein the sound detection unit includes a second microphone array disposed inside relative to the sound generation unit.

6. The acoustic active sensor device according to claim 1, wherein
the acoustic actuator further includes a magnetic circuit that generates a magnetic flux for vibrating the sound generation unit,
a hole portion is formed in a center part of the magnetic circuit in plan view, and
the camera unit is disposed in the hole portion.

7. The acoustic active sensor device according to claim 1, wherein regarding a front traveling direction of a sound generated by the sound generation unit, a front end part of the camera unit protrudes forward relative to the front end part of the sound generation unit.
